(19) United States
(12) Patent Application Publication
(10) Pub. No.: US 2017/0198399 A1
(43) Pub. Date: Jul. 13, 2017

(54) Quantification Method for the Activity of a Chemical Plating Solution, and Method and Apparatus for Measuring the Activity of the Chemical Plating Solution

(71) Applicants: Tyco Electronics (Shanghai) Co. Ltd., Shanghai (CN); TE Connectivity Corporation, Berwyn, PA (US)

(72) Inventors: Zhenyu Zhu, Shanghai (CN); Jiankun Zhou, Shanghai (CN); Min Zheng Haeberle, Berwyn, PA (US); Zhongxi Huang, Shanghai (CN)

(73) Assignees: Tyco Electronics (Shanghai) Co. Ltd., Shanghai (CN); TE Connectivity Corporation, Berwyn, PA (US)

(21) Appl. No.: 15/404,382

(22) Filed: Jan. 12, 2017

(30) Foreign Application Priority Data
Jan. 12, 2016 (CN) 201610018003.7

(51) Int. Cl. C23C 18/16; C23C 18/38; G01N 27/02

(52) U.S. Cl. CPC C23C 18/168; G01N 27/026; C23C 18/1683; C23C 18/38; G01N 27/028; C23C 18/1676

(57) ABSTRACT

A method and apparatus for quantifying an activity of a chemical plating solution in a chemical plating system is disclosed. The method comprises performing an electrochemical impedance spectrum (EIS) measurement on one or more chemical plating solutions in the chemical plating system, processing data for each EIS measurement result to obtain a corresponding charge transfer resistance value, obtaining a correspondence between the activity and the charge transfer resistance value in each chemical plating solution, and quantifying the activity of each chemical plating solution in the chemical plating system using the correspondence to the charge transfer resistance value.

### CROSS-REFERENCE TO RELATED APPLICATION

This application claims the benefit of the filing date under 35 U.S.C. §119(a)-(d) of Chinese Patent Application No. 201610018003.7, filed on Jan. 12, 2016.

### FIELD OF THE INVENTION

The present invention relates to chemical plating, and more particularly, to quantifying the activity of a chemical plating solution.

### BACKGROUND

During chemical plating, the activity of a chemical solution plays a crucial role in the quality of the resulting chemically plated product. The activity of the chemical solution determines the starting time of the chemical plating and the adjustment of the operation parameters in the production process. A starting time that is too early or too late will result in not only products with defects, due to issues such as skip plating and overflow plating, but also low productivity. Additionally, during the production, the operation parameters, such as the chemical composition, the temperature, the pneumatic blending, and the like, must be adjusted according to the solution activity. It has been shown in practice that wrong estimation of the activity during production not only results in a high proportion of defective products but also shortens the life-time of the chemicals.

Generally, a higher activity corresponds to a faster reaction. At present, the bubble observation method is used as the traditional method for estimating the solution activity in the production process. More bubbles at the surface of the reaction represent a higher solution activity. This estimation method is subjective and crude, depending primarily on the production experience of the operator to estimate and adjust the solution activity, lacking objectivity and the ability of quantitative measurement. Hence, traditional methods often result in wrong estimation and product defects. Although generally a weighing method is used in the lab to estimate the average rate of the chemical reaction of a solution during a period, it takes a relatively long time and has no real value in the production. There is still no method that can quantitatively measure the instant activity of a solution on the production line, and there is still no method or apparatus that can quantitatively measure the instant activity of a chemical plating solution on the production line to control the production process. There is therefore a need for a method and an apparatus that can measure the activity of a chemical plating solution in industry rapidly and accurately.

Electrochemical impedance spectrum (EIS) is an electric measurement method which uses the potential of a small amplitude sine wave as a perturbation signal. In EIS, the interference is small, information for the interface state and process is provided, the process of data analysis is relatively simple, and the results are reliable.

CN102227628A proposes a method for controlling the concentration of a stable additive in an electrolyte solution for the electroless plating of a metal and metallic alloy by using a voltammetric measurement. Results from the electrochemical impedance spectrum (EIS) of the EDTA-based electrolyte solution for the electroless plating of copper and the constant-coulomb-measurement are provided (J. Electrochem. Soc. 135 (1988) 1645-1650). The concentration of the stable additive 2-mercaptobenzothiazole on the platinum electrode was measured by evaluating the double layer capacitance and the polarization resistance.

CN101831641B proposes an acidic zincating solution and zincating method for a magnesium-aluminum alloy. The EIS measurement is performed for that system, and an equivalent circuit, which comprises the solution resistance, the membrane capacitance, the membrane resistance, the double layer capacitance at the solution/electrode interface, and the electrochemical reaction resistance, is obtained by fitting. According to the analysis of each element of the equivalent circuit, the corrosion resistance of the substrate is estimated.

No method for characterizing the activity of a chemical plating solution by means of the charge transfer resistance value in EIS is described in the prior art.

### SUMMARY

An object of the invention, among others, is to provide a method and apparatus for rapid and accurate measurement of the activity of a chemical plating solution. The disclosed method comprises performing an electrochemical impedance spectrum (EIS) measurement on one or more chemical plating solutions in the chemical plating system, processing data for each EIS measurement result to obtain a corresponding charge transfer resistance value, obtaining a correspondence between the activity and the charge transfer resistance value in each chemical plating solution, and quantifying the activity of each chemical plating solution in the chemical plating system using the correspondence to the charge transfer resistance value.

### BRIEF DESCRIPTION OF THE DRAWINGS

The invention will now be described by way of example with reference to the accompanying Figures, of which:

FIG. 1 is a schematic of a system performing an EIS measurement according to the invention;

FIG. 2 is a circuit diagram of an equivalent circuit fitted to the EIS measurement of a chemical plating solution by the system of FIG. 1;

FIG. 3 is a Nyquist diagram of the EIS measurement of the chemical plating solution by the system of FIG. 1;

FIG. 4 is a relationship curve of a charge transfer resistance and a deposition rate of an exemplary chemical plating of copper determined by the system of FIG. 1; and

FIG. 5 is a schematic of an apparatus for quantitative measurement of an activity of a chemical plating solution according to the invention.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

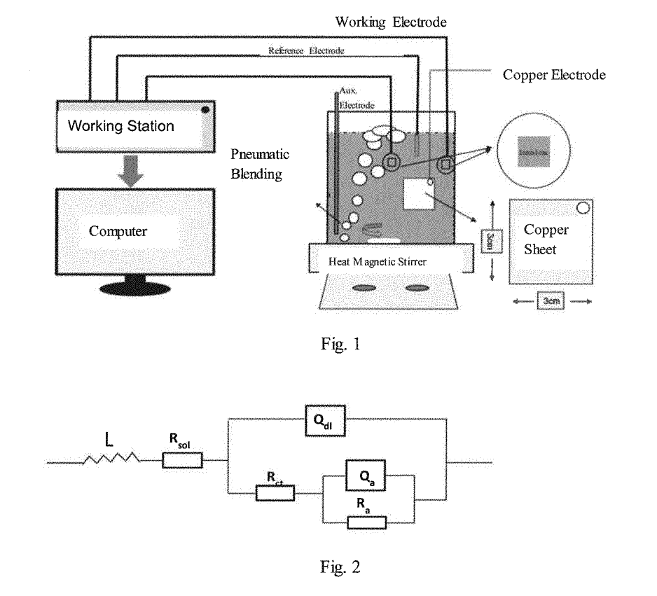

The present invention provides a quantification method of the activity or deposition of a chemical plating solution. The quantification method quantifies the activity of a chemical plating solution by the charge transfer resistance value calculated from the result obtained from an EIS measurement performed in the chemical plating solution. The quantification method of the present invention will be described with reference to an exemplary embodiment shown in FIGS. 1-5 quantifying the activity of a solution for chemically plating copper.

A system performing an EIS measurement according to the invention is shown in FIG. 1. The chemical plating solution is first formed. In the embodiment shown in FIG. 1, the solution has concentrations of 2.7 g/L of Cu ions, 4 g/L of HCHO, 8 g/L of NaOH, and 24 ml/L of a complexing agent. The solution is placed on a magnetic stirring plate and heated to 55° C. at a magnetic stirring speed of 800-1200 rpm. Air is simultaneously introduced into the solution via pneumatic blending to enhance the stirring intensity.

In the EIS measurement, a three-electrode system is used with a working electrode, an auxiliary electrode and a reference electrode as shown in FIG. 1. The reference electrode is a saturated calomel electrode and the working electrode and the auxiliary electrode are metal electrodes made of the same material, such as a copper electrode. Thus, the potential difference caused by the difference in the materials of the working electrode and the auxiliary electrode can be eliminated, so that the measurement result is more precise. The metal electrode is a sheet electrode having an area of 1 cm²-10 cm²; in the embodiment shown in FIG. 1, the working electrode and the auxiliary electrode are each a copper sheet of 1 cm×1 cm.

The three electrodes are immersed in the chemical plating solution as shown in FIG. 1. The alternative current impedance measurement is then performed using the Working Station shown in FIG. 1. In the shown embodiment, the measurement begins with a testing potential of −0.75V and a testing frequency of 10⁻² to 10⁻⁵ HZ. In other embodiments, a measurement frequency varying in 10⁵-10⁻² HZ may be used. This frequency range is sufficient to give a satisfying measurement result for the data processing. Further, in other embodiments, a potential within the range of the open circuit potential ±0.2V is used as the input voltage. In this range, the electrodeposition of the metal ions can be avoided, the dispersion of the data is little, and the alternative current impedance data and diagram meeting the requirements can be obtained.

Meanwhile, in the embodiment shown in FIG. 1, a thin copper sheet of 3 cm×3 cm on two surfaces of which deposition occurs is put into the solution to perform the chemical deposition. The deposition rate of the chemical plating copper during this period is calculated from the mass difference between the copper sheet before the deposition and the copper sheet after the deposition as well as the density of metal copper. The weight difference is divided by time to obtain the deposition rate. This weighing method to calculate deposition rate is a well-known method in the art. The deposition rate is measured once every half hour. Those skilled in the art know that other methods also can be used to estimate the deposition rate, in addition to the weighing method; for example, microscopy may be used to observe the thickness of the plating layer.

The EIS calculations are performed on the Computer shown in FIG. 1. On the basis of the result of the EIS, the equivalent circuit of the solution reaction system can be derived. This equivalent circuit comprises elements, such as an inductor L, a resistor R, a constant phase angle element Q, and the like. The derived equivalent circuit is fitted by a Nyquist diagram to obtain the value of each element in the circuit. Among them, the charge transfer resistance R_{ct} of the system corresponds to the reaction activity or reaction rate of the solution.

Specifically, impedance data and the Nyquist diagram at different alternative frequencies can be obtained from the EIS measurement. According to the Nyquist diagram, the equivalent circuit of the electrochemical system is fitted, and thus the charge transfer resistance can be derived. The above-mentioned data processing process for the EIS measurement result is performed generally by using computer software stored in a non-transitory computer readable medium on the Computer. The impedance data are inputted to the computer software, then the equivalent circuit diagram matching the Nyquist diagram is chosen, and thereby the value of each circuit element (including R_{ct}) therein can be calculated by the software. An example of the computer softwares that may be used in the present invention is ZSimpWin Demo provided by the Echem Software company.

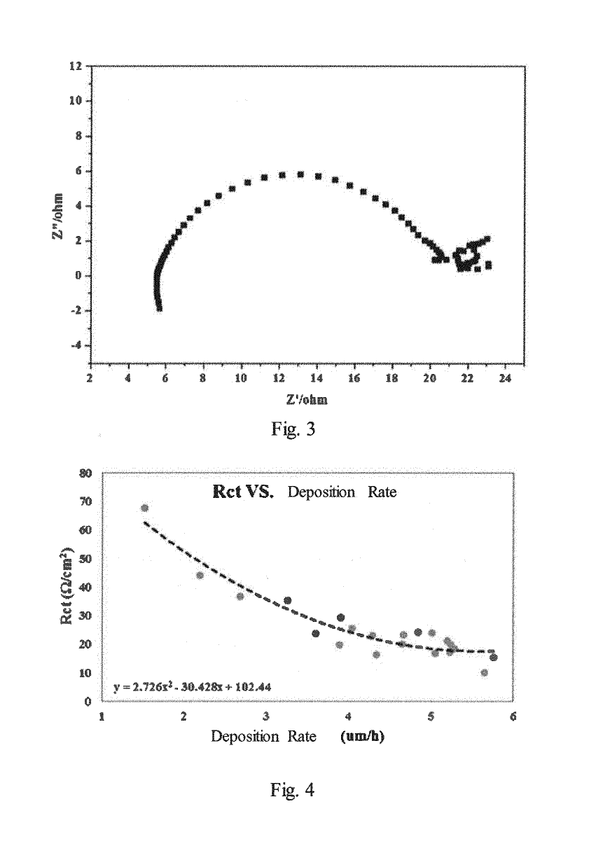

For the chemical plating system shown in the exemplary embodiment of FIG. 1, after fitting using the aforementioned software, the circuit diagram shown in FIG. 2 is the optimal fitted circuit. FIG. 3 shows the Nyquist diagram of one testing point therein.

The fitted numerical values of the R_{ct} in the circuit diagram by the software are recorded, and the fitting results from the exemplary embodiment of FIG. 1 are shown in Table 1. Table 1 also lists the plating deposition rates measured correspondingly. From the R_{ct} values and the corresponding deposition rates, the equation of the R_{ct} and the deposition rate, i.e. y=2.726x²−30.428x+102.44, was simulated by the Computer, wherein y was the R_{ct} value and x was the deposition rate. The curve of the function is shown in FIG. 4. The deposition rate corresponds to the reaction activity in the chemical plating solution for copper. Thereby, the reaction activity in the chemical plating solution for copper is obtained quantitatively by the EIS measurement.

TABLE 1

| | | | Q_{dl} | | | Qₐ | | | Plating |
|---|---|---|---|---|---|---|---|---|---|
| | | Rₛₒₗ | Yₒ | | R_{ct} | Y₁ | | Rₐ | rate |
| No. | L | Ω/cm² | μF/cm² | n_{dl} | Ω/cm² | μF/cm² | n_{dl} | Ω/cm² | (μm/h) |
| 1 | 2.503E−6 | 6.021 | 0.0002277 | 0.8136 | 19.87 | 1.345 | 0.4223 | 3.112E9 | 3.89 |
| 2 | 2.597E−6 | 6.031 | 0.0002235 | 0.8095 | 20.13 | 1.067 | 0.5673 | 7.006E6 | 4.65 |
| 3 | 2.678E−6 | 5.936 | 0.0001866 | 0.8329 | 18.36 | 0.7147 | 0.4092 | 1.947E9 | 5.28 |
| 4 | 2.937E−6 | 5.833 | 0.0001883 | 0.8303 | 23.13 | 0.4681 | 0.5321 | 15.58 | 4.29 |
| 5 | 2.753E−6 | 6.232 | 0.000168 | 0.8378 | 35.34 | 0.5519 | 0.4961 | 3.192E6 | 3.26 |
| 6 | 2.741E−6 | 5.95 | 0.0001654 | 0.8464 | 29.38 | 0.8092 | 0.5996 | 32.27 | 3.91 |
| 7 | 2.751E−6 | 5.934 | 0.0001849 | 0.86 | 16.37 | 0.4163 | 0.794 | 2.313 | 4.34 |
| 8 | 2.86E−6 | 5.992 | 0.000175 | 0.8501 | 23.84 | 0.4541 | 0.6056 | 8.274 | 3.60 |
| 9 | 2.658E−6 | 6.536 | 0.0001796 | 0.8363 | 44.18 | 0.23 | 0.5982 | 13.73 | 2.19 |
| 10 | 2.242E−6 | 7.213 | 0.0001709 | 0.8344 | 67.67 | 0.848 | 1 | 15.48 | 1.52 |
| 11 | 3.903E−6 | 5.402 | 0.0002342 | 0.8209 | 10.16 | 0.1959 | 0.1032 | 1.454E19 | 5.65 |
| 12 | 3.759E−6 | 5.436 | 0.0002092 | 0.8216 | 15.34 | 0.9019 | 0.3665 | 1.447E6 | 5.76 |
| 13 | 3.59E−6 | 5.432 | 0.0001688 | 0.8413 | 17.21 | 0.7018 | 0.3205 | 1.874E10 | 5.22 |
| 14 | 3.489E−6 | 5.492 | 0.0001446 | 0.8578 | 16.79 | 0.3649 | 0.1723 | 2.547E9 | 5.05 |
| 15 | 3.477E−6 | 5.477 | 0.0001486 | 0.8534 | 20.12 | 0.4729 | 0.2593 | 1.254E11 | 5.23 |
| 16 | 3.422E−6 | 5.523 | 0.0001488 | 0.8531 | 21.15 | 0.82 | 0.3613 | 1.136E8 | 5.19 |
| 17 | 3.461E−6 | 5.469 | 0.0001578 | 0.8482 | 23.88 | 0.7322 | 0.4012 | 1.577E9 | 5.01 |
| 18 | 3.475E−6 | 5.39 | 0.0001494 | 0.8565 | 23.26 | 0.59 | 0.3781 | 59.69 | 4.66 |
| 19 | 3.471E−6 | 5.398 | 0.0001524 | 0.8551 | 24.32 | 1.167 | 0.5134 | 2.031E8 | 4.84 |
| 20 | 3.425E−6 | 5.49 | 0.0001509 | 0.8602 | 25.65 | 0.5322 | 0.5233 | 15.09 | 4.04 |
| 21 | 3.29E−6 | 5.825 | 0.0001469 | 0.8555 | 36.8 | 0.3266 | 0.5525 | 15.83 | 2.68 |

The activity of a chemical plating solution, according to the invention as described above, can consequently be characterized by the charge transfer resistance R_{ct} value in the chemical plating solution equivalent circuit, which is, after the chemical plating solution has been subjected to the EIS measurement, obtained from the results of the measurement. Specifically, for a chemical plating solution system, when the activity of the solution is changing, the R_{ct} value thereof will change therewith, and the R_{ct} value corresponds to the solution activity one-to-one. Many factors, such as the composition, the temperature, the flow of the solution, or the like, can affect the activity of the chemical plating solution in the process of the chemical plating. However, as long as the solution activity is constant, the R_{ct} value, to which the activity corresponds, is constant. That is to say, the same R_{ct} value represents the same solution activity provided the same chemical plating system.

During the plating of a sheet, operation parameters of the plating, such as the aforementioned composition, the heating temperature, the stirring speed, and the degree of pneumatic blending of the chemical plating solution are read by the Computer and adjusted by the Computer according to the determined R_{ct} value representing the solution activity to optimize the activity and properly plate the sheet. Furthermore, based on the determined R_{ct} value, a starting time of the chemical plating can also be determined and initiated by the Computer.

The correspondence between the activity and the charge transfer resistance value of a chemical plating solution, or in particular, the correspondence between the deposition rate and the charge transfer resistance value of the chemical plating solution, can be represented in various forms. For example, their relationship may be represented graphically by plotting and fitting. Alternatively, their functional relationship can be obtained by fitting via functions. The correspondence also can be listed as a numerical table, or be stored as a database that can be used by a computer.

Those skilled in the art can understand that such a quantification method exhibits various implementations in practice. For example, when an operator has a first chemical plating solution having an ideal deposition rate or activity, the charge transfer resistance value representing this ideal activity can be obtained by the quantification method. Further, whether the charge transfer resistance value of a second solution having an unknown activity in the same system deviates from this value corresponding to the ideal activity is used to estimate whether the second solution has an ideal activity. The charge transfer resistance values of two solutions in the same system can be compared to determine whether the respective activities of the two solutions are essentially the same.

The correspondence between the activity and the charge transfer resistance value of the chemical plating solution is represented by the correspondence between the deposition rate and the charge transfer resistance value of the chemical plating solution. This correspondence may be obtained by performing the EIS measurement and the weighing method for the chemical plating solution at the same time during the deposition process. As mentioned above, typically, the charge transfer resistance decreases, as the reaction activity increases. That is to say, the charge transfer resistance decreases, as the deposition rate increases.

In addition to serving as criteria for a single point, correspondences between a plurality of activities and charge transfer resistance values can be used for establishing a quantitative description of the chemical plating system as a whole. A charge transfer resistance value exhibits essentially a trend of monotonical decreasing as the activity increases. Therefore, for example, given the charge transfer resistance values to which two activities correspond, respectively, it can be estimated that a solution having a charge transfer resistance value between these two values in the same system would also essentially have an activity between these two activities. If sufficient quantification measurement points are obtained in the system, for those skilled in the art, the binary correspondence can be shown graphically by a graph, be shown as a function by function fitting, or be shown as a numerical table or a database, for various uses relating to the specific value of the activity.

In another aspect, the present invention provides a method for quantitatively measuring the activity of a chemical plating solution in a chemical plating system. The method comprises obtaining previously the correspondence between the activity and the charge transfer resistance value of a chemical plating solution, which is in the same chemical plating system as the chemical plating solution to be measured; performing an EIS measurement on the chemical plating solution to be measured, and performing a data processing, to obtain the charge transfer resistance value; and comparing the charge transfer resistance value of the chemical plating solution to be measured with the correspondence, to quantitatively measure the activity of the chemical plating solution to be measured.

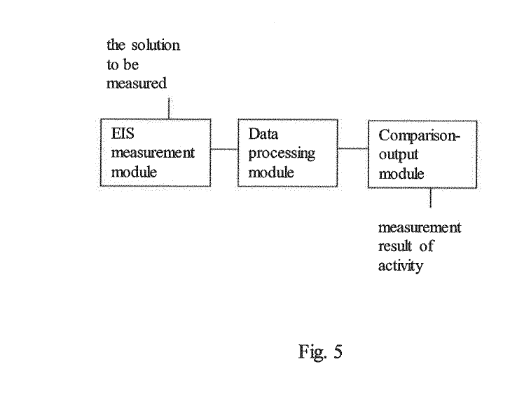

An apparatus for quantitative measurement of the activity of a chemical plating solution according to the invention is shown in FIG. 5. The apparatus comprises an EIS measurement module, a data processing module, and a comparison-output module. As shown in FIG. 5, the EIS measurement module performs an EIS measurement on the chemical plating solution. The data processing module determines the charge transfer resistance value from the EIS measurements received from the EIS measurement module. The data processing module may fit the equivalent circuit of the chemical plating solution by the Nyquist diagram from the EIS measurement result and obtains the charge transfer resistance value.

The comparison-output module compares the charge transfer resistance value obtained from the data processing module with an existing correspondence between the activity and the charge transfer resistance value of the chemical plating solution, and outputs the activity of the corresponding chemical plating solution. Generally, in the comparison-output module, the existing correspondence between the activity of a chemical plating solution and the charge transfer resistance value can be stored as a form that can be treated by a computer. The comparison-output module also adjusts the operation parameters of the plating based on the determined activity, including adjusting the composition, the heating temperature, the stirring speed, and the degree of pneumatic blending of the chemical plating solution, to optimize the activity. The comparison-output module also determines and initiates a starting time of the chemical plating.

Advantageously, in the method and apparatus for measuring the activity of a chemical plating solution according to the invention, the charge transfer resistance value obtained from the EIS measurement can be used to determine the activity of a solution. The EIS measurement and the data processing take a very short time, and therefore, the method and apparatus according to the invention can trace the state of the activity of the solution during the production efficiently and conveniently. After obtaining the relationship between the charge transfer resistance value and the deposition rate by using the EIS measurement and the weighing method at the same time, the corresponding deposition rate can be directly known from the charge transfer resistance value obtained by the EIS measurement and the data analysis of other solutions. By contrast, previous quantification methods for the activity of a solution are mainly non-instant measurement methods, such as the weighing method which requires removing the plated substrate from the solution, which takes a long time and interrupts production.

What is claimed is:

1. A quantification method for quantifying an activity of a chemical plating solution in a chemical plating system, comprising:
performing an electrochemical impedance spectrum (EIS) measurement on one or more chemical plating solutions in the chemical plating system;
processing data for each EIS measurement result to obtain a corresponding charge transfer resistance value;
obtaining a correspondence between the activity and the charge transfer resistance value in each chemical plating solution; and
quantifying the activity of each chemical plating solution in the chemical plating system using the correspondence to the charge transfer resistance value.

2. The quantification method according to claim 1, wherein the processing step comprises fitting an equivalent circuit of the chemical plating solution using a Nyquist diagram from the EIS measurement result to obtain the charge transfer resistance value.

3. The quantification method according to claim 1, wherein the EIS measurement is carried out in a three electrode system, using a potential within the range of the open circuit potential ±0.2V as an input voltage, and using a measurement frequency of 10⁵-10⁻² HZ.

4. The quantification method according to claim 3, wherein the three electrodes include a reference electrode, a working electrode, and an auxiliary electrode, the reference electrode is a saturated calomel electrode and the working electrode and the auxiliary electrode are made of a same metal.

5. The quantification method according to claim 4, wherein the working electrode is a sheet electrode having an area of 1 cm²-10 cm².

6. The quantification method according to claim 1, wherein the activity of the chemical plating solution is a deposition rate of the chemical plating solution.

7. The quantification method according to claim 6, wherein the deposition rate of the chemical plating solution is obtained by a weighing method, which is carried out at the same time as the EIS measurement.

8. The quantification method according to claim 1, wherein the correspondence is in the form of function, graph, numerical table, or database.

9. A method for quantitatively measuring an activity of a chemical plating solution in a chemical plating system, comprising:
obtaining a correspondence between the activity and a charge transfer resistance value of a first chemical plating solution, the first chemical plating solution in a same chemical plating system as a second chemical plating solution;
performing an electrochemical impedance spectrum (EIS) measurement on the second chemical plating solution;
processing the EIS measurement to obtain a charge transfer resistance value of the second chemical plating solution; and
comparing the charge transfer resistance value of the second chemical plating solution with the correspondence to quantitatively determine an activity of the second chemical plating solution.

10. The method according to claim 9, wherein the processing step comprises fitting an equivalent circuit of the chemical plating solution using a Nyquist diagram from the EIS measurement result to obtain the charge transfer resistance value.

11. An apparatus for quantitatively measuring an activity of a chemical plating solution in a chemical plating system, comprising:
an electrochemical impedance spectrum (EIS) measurement module performing an EIS measurement on the chemical plating solution;
a data processing module receiving the EIS measurement from the EIS measurement module and determining a charge transfer resistance value from the EIS measurement; and
a comparison-output module comparing the charge transfer resistance value obtained from the data processing module with a stored correspondence between the activity of the chemical plating solution and the charge transfer resistance value, the comparison-output module outputting the activity of the chemical plating solution.

12. The apparatus according to claim 11, wherein the data processing module fits an equivalent circuit of the chemical plating solution using a Nyquist diagram from the EIS measurement result to obtain the charge transfer resistance value.

13. The apparatus according to claim 11, wherein the activity of the chemical plating solution is a deposition rate of the chemical plating solution.

14. A method for quantifying and adjusting an activity of a chemical plating solution in a chemical plating system, comprising:
performing an electrochemical impedance spectrum (EIS) measurement on one or more chemical plating solutions in the chemical plating system;
processing data for each EIS measurement result to obtain a corresponding charge transfer resistance value;
obtaining a correspondence between the activity and the charge transfer resistance value in each chemical plating solution;
quantifying the activity of each chemical plating solution in the chemical plating system using the correspondence to the charge transfer resistance value; and
adjusting operation parameters of the chemical plating system based on the quantified activity of each chemical plating solution.

15. The method according to claim 14, wherein the operation parameters are at least one of a composition, a heating temperature, a stirring speed, and a degree of pneumatic blending of the chemical plating solution.

16. The method according to claim 14, further comprising determining a starting time of a chemical plating in the chemical plating system based on the quantified activity of each chemical plating solution.

17. The method according to claim 16, further comprising initiating the chemical plating based on the determined starting time.

18. The method according to claim 14, wherein the activity of the chemical plating solution is a deposition rate of the chemical plating solution.
